(19) United States
(12) Patent Application Publication
(10) Pub. No.: US 2026/0316913 A1
(43) Pub. Date: Oct. 15, 2026

(54) WIND-ASSISTED PROPULSION SYSTEM AND BOAT PROVIDED WITH SUCH A SYSTEM

(71) Applicant: CENT RECH ARCHIT INDU NAUTIQUE, La Rochelle (FR)

(72) Inventors: Philippe Pallu de la Barrière, La Rochelle (FR); Jérôme Vedrenne, La Baule (FR)

(73) Assignee: CENT RECH ARCHIT INDU NAUTIQUE, La Rochelle (FR)

(21) Appl. No.: 19/106,873

(22) PCT Filed: Aug. 30, 2023
(86) PCT No.: PCT/FR2023/051317

§ 371 Date: Dec. 2, 2025

(30) Foreign Application Priority Data
Aug. 31, 2022 (FR) FR2208737

(51) Int. Cl. B63H 9/02; B63B 79/15; B63B 79/40

(52) U.S. Cl. CPC B63H 9/02; B63B 79/15; B63B 79/40

(57) ABSTRACT

The invention relates to a method for controlling the angle of incidence (A1) of a wing (100) of a wind-assisted propulsion system (1), the method comprising the steps of: measuring a parameter representative of the state of separation of the airflow (F1) incident on the wing as a function of the angle of incidence (A1) of the wing (100); determining a value (A1D_t2) for the angle of incidence of the wing (100) corresponding to a stall; determining a safety value (A1SD1_t2) for the angle of incidence of the wing as a function of the stall angle value (A1D_t2) which is lower than the stall angle value; controlling the orientation of the wing with an angle of incidence set value that is equal to the angle of incidence safety value (A1SD1_t2). The invention also relates to a system and a corresponding boat.

### FIELD OF THE INVENTION

The present invention generally relates to the wind-assisted propulsion systems for boat, also called wind-assisted propellers.

### PRIOR ART

We know from the state of the art, and in particular from document FR2503286A2, wind-assisted propellers which comprise an elongated hollow body, suction areas provided along the peripheral wall of the hollow body and suction means making it possible to generate an airflow inside the hollow body. The suction at the peripheral wall of the propeller makes it possible to limit the separation of the airflow from the wall of the propeller.

A lifting profile, also called a wing, makes it possible to generate lift, in the aerodynamic sense, that is to say a force perpendicular to the direction of the flow in which the wing is placed, which makes it possible to carry out a wind-assisted propulsion system for a ship, such as a cargo.

For a given configuration of the wing, the generated lift is mainly dependent on the angle of incidence of the wing, that is to say the angle between the chord line of the profile of the wing and the direction of the incident airflow. For a wind-assisted propulsion system mounted on a boat, the incident flow on the wing is the apparent wind perceived by the wing, which is the result of the wind perceived by an observer present on the boat and stationary relative to the boat, and of the wind created by the displacement (speed) of the boat.

The lift increases steadily with the angle of incidence up to a maximum value. Beyond this point of maximum lift, the lift decreases more or lower suddenly, which corresponds to stall.

Prior to using the wing, it is possible to estimate the angle of incidence from which the stall is likely to occur, i.e. the stall angle, as a function of the shape (profile) of the wing, in order to define an angle of incidence range authorized for the pivoting control of the wing. However, the estimation of the stall angle remains unreliable, variable depending on the environmental conditions, and it is then necessary to define a significant safety margin between the maximum authorized angle of incidence and the estimated stall angle so that the wing does not suffer from an untimely stall.

Document U.S. Pat. No. 4,582,013 A describes a machine for recovering wind energy which uses a self-adjusting aerodynamic blade and an aerodynamic roller. Sensors monitor the operating conditions.

Document WO2014085835 A describes a wing of variable shape, movable in increments between a neutral configuration and a deformed configuration. The wing takes a reflexed camber airfoil section shape in the deformed configuration.

The aim of the present invention is to propose a new wind-assisted propulsion system and a corresponding method making it possible to overcome all or part of the problems disclosed above.

### SUMMARY OF THE INVENTION

To this end, the subject of the invention is a method for controlling the angle of incidence of a lift generating device, called a wing, of a wind-assisted propulsion system relative to the direction of the apparent wind, the wing comprising a hollow body, the wing being located in an outer airflow incident on the wing; the wind-assisted propulsion system comprising:
a suction device in fluid communication with the hollow body;
at least one suction opening provided in a peripheral wall of the hollow body subjected to said outer airflow incident on the wing, the suction device generating an air flow inside the hollow body from said at least one suction opening;
a device for measuring a parameter representative of the state of separation of the airflow incident on the wing;
a motorized system for pivoting the wing about a vertical pivot axis parallel to the longitudinal axis of the hollow body;
a drive unit;
   characterized in that the method comprises the following steps:
a) measuring the direction of the apparent wind by a device for measuring direction of the apparent wind;
b) pivotally displacing the wing about the vertical pivot axis by the motorized system for pivoting the wing, to allow the chord line of the profile of the wing to take different values for the angle of incidence relative to the direction of the apparent wind, and,
c) during the pivotal displacement of the wing, measuring, by said device for measuring parameter representative of the state of separation, said parameter representative of the state of separation of the airflow incident on the wing as a function of the angle of incidence value of the wing; and, from the measurement of said parameter representative of the state of separation of the airflow incident on the wing, determining by the drive unit a value for the angle of incidence of the wing corresponding to a stall, called a stall angle value;
d) determining by the drive unit a safety value for the angle of incidence of the wing, as a function of said stall angle value, the angle of incidence safety value of the wing being, in absolute value, lower than said stall angle value;
e) controlling by the drive unit the orientation of the wing with an angle of incidence set value that is equal to the angle of incidence safety value.

Such a design of the wind-assisted propulsion system makes it possible to reliably detect the stall angle and to reduce the safety margin between the maximum authorized angle of incidence and the stall angle in order to be able to benefit from a lift force close to the maximum lift force, while limiting the risk of stall.

The drive unit may define the maximum authorized angle of incidence as a function of this measured stall angle, as being equal to the value of this stall angle (in absolute value) that is reduced by a safety value which is smaller than that which should be used if the stall angle were simply estimated as a function of the shape of the wing. The system may then provide a lift force closer to the maximum lift force thanks to the measurement of the stall angle which makes it possible to adapt the authorized angle of incidence range to the measured stall angle to be able to approach the stall angle in order to benefit from significant lift, while limiting the risk of unintentional stall.

Measuring or learning the stall angle thus makes it possible to adjust the position and the extent of the incidence operating area of the wing according to the stability of the operational conditions. Measuring or learning the stall angle, and not a simple estimation, also makes it possible to reduce the angle of incidence when it turns out that a premature stall of the wing has occurred.

The system may thus maximize over time the propulsive efforts generated on the ship, due to the fact that measuring the stall angle allows it to update the stall angle value to be taken into account and to use an appropriate safety margin between the maximum authorized angle of incidence and the measured stall angle, which allows the wing to best approach the point of maximum lift while avoiding stall. The efficiency of the system is thus improved since the aerodynamic operating point which maximizes the propulsive force is frequently the point of maximum lift.

The wind-assisted propulsion system is thus configured to detect the stall of the wing, and use the corresponding measured stall angle to reliably and efficiently define a maximum authorized angle of incidence making it possible to improve the operating efficiency of the system by making it possible to achieve high lift values while reducing the risk of unintentional stall. Taking into account the stall angle makes it possible to effectively check the driving of the system.

The measurement of the angle of the apparent wind is preferably carried out in the vicinity of the system. The apparent wind direction sensor may be fastened to the system, such as a wind vane located above the system.

The wind-assisted propulsion system and the corresponding method thus make it possible to correct or dispense with an estimation, by definition approximate, of the theoretical stall angle, by actually testing the stall angle or taking into account a stall experienced at a given angle to determine the actual stall angle.

In other words, the control method and the corresponding system thus make it possible to pivotally displace the wing to measure the state of separation of the air during the pivoting of the wing and determine precisely and reliably the actual stall angle from the carried out measurements, and thus reduce the safety margin between the maximum authorized angle of incidence and the stall angle.

Conversely, in the state of the art, only an estimation of the angle at which the stall is likely to occur is carried out, prior to using the wing. However, the estimation of the angle likely to stall remains unreliable, variable depending on the environmental conditions, and it is then necessary to define a significant safety margin between the maximum authorized angle of incidence and the stall angle estimated so that the wing does not suffer an untimely stall.

Thanks to the control method and the corresponding system according to the invention, the user (navigator) does not need to intervene himself in adjusting the wind-assisted propeller. It should be noted that in the state of the art, the user does not have the data as such which would make it possible to judge stall on a wind-assisted propeller, in particular when it is fitted to a cargo ship.

The system may also comprise one or several of the following characteristics taken in any technically admissible combination.

According to one embodiment, after a first process of execution of steps a) to e) providing a first stall angle value and a first safety value for the angle of incidence, steps a) to e) are repeated in a second execution process so as to obtain a second stall angle value and a second safety value for the angle of incidence corresponding to an update of the angle of incidence safety value. According to a particular aspect, the angular sector in which the wing is pivotally displaced extends on either side of the stall angle value obtained during the first execution process.

According to one embodiment, in step b) of the second execution process, the wing is displaced until a stall is detected and/or the angular sector in which the wing is pivotally displaced extends on either side of the stall angle value obtained during the first execution process. The pivotal displacement of the wing is preferably carried out so as to reach or exceed (i.e. pass through) the angle previously determined as the stall angle.

According to one embodiment, after the first process of execution of steps a) to e) providing a first stall angle value and a first safety value for the angle of incidence, the method comprises the following steps preferably performed at a given frequency, for example 10 Hz:
determining the angular position where the wing is located, to which corresponds a value for the angle of incidence of the wing, and measuring said parameter representative of the state of separation of the airflow incident on the wing; and,
determining by the drive unit the state of stall or not of the wing as a function of said measured parameter representative of the state of separation of the airflow incident on the wing;
   and, in case of detection of a state of stall:
either steps a) to e) are repeated in a second execution process;
either, assigning to the stall angle value, by the drive unit, said determined angle of incidence value of the wing;
   determining by the drive unit a safety value for the angle of incidence of the wing as a function of said stall angle value, the angle of incidence safety value being, in absolute value, lower than said stall angle value;
   controlling by the drive unit the orientation of the wing with an angle of incidence set value that is equal to the angle of incidence safety value.

According to one embodiment, the device for measuring a parameter representative of the state of separation of the airflow incident on the wing comprises a pressure sensor system configured to measure the pressure in the air flow inside the hollow body.

According to one embodiment, the pressure sensor system is configured to measure the pressure in the air flow inside the hollow body between said at least one suction opening and the suction device.

According to one embodiment, the pressure sensor system comprises a sensor of the differential pressure sensor type, the differential pressure sensor comprising a pressure tap which is located inside the hollow body.

According to one embodiment, the wing comprising a fairing coupled to the peripheral wall of the hollow body, the differential pressure sensor comprises a reference pressure tap which is located in the fairing.

According to one embodiment, the angle of incidence safety value, denoted A1SD1_t2, is calculated according to the formula:

$$‖ A 1 SD 1 \_t 2 ‖ = ‖ A 1 D\_t 2 ‖ - as$$

with as a strictly positive value, referred to as the spacing value, and A1D_t2 being the stall angle value.

According to one embodiment, said spacing value is a predefined value.

According to one embodiment, said spacing value is a function of the speed of the apparent wind.

According to one embodiment, said stall angle value is determined as being the angle of incidence value for which the parameter representative of the state of separation of an airflow incident on the wing crosses a threshold value and/or has a slope value which crosses a threshold value.

According to one embodiment, the direction of the apparent wind is measured using a wind vane positioned on the wing.

According to one embodiment, the device for measuring a parameter representative of the state of separation of the airflow incident on the wing comprises a wall pressure sensor, positioned on the wing in the airflow incident upstream of said at least one suction opening.

According to one embodiment, the device for measuring a parameter representative of the state of separation of the airflow incident on the wing comprises a flexible strip associated with electronic processing means, called an electronic telltale, positioned on the wing in the airflow incident upstream of said at least one suction opening.

According to one embodiment, the device for measuring a parameter representative of the state of separation of the airflow incident on the wing comprises a device for analyzing operating parameter(s) of the suction device. The invention also relates to a wind-assisted propulsion system comprising:
a lift generating device, called a wing, the wing comprising a hollow body, the wing being intended to be located in an outer airflow incident on the wing;
a suction device in fluid communication with the hollow body;
at least one suction opening provided in a peripheral wall of the hollow body capable of being subjected to said outer airflow incident on the wing, the suction device being configured to generate an air flow inside the hollow body from said at least one suction opening;
a device for measuring a parameter representative of the state of separation of the airflow incident on the wing;
a motorized system for pivoting the wing about a pivot axis parallel to the longitudinal axis of the hollow body;
a drive unit configured to execute the steps of a method for controlling the angle of incidence of the wing relative to the direction of the apparent wind, the method being in accordance with any one of the preceding embodiments.

The invention also relates to a boat equipped with the wind-assisted propulsion system, the wind-assisted propulsion system being mounted on the deck of the boat.

According to a preferred embodiment, the parameter relative to the state of the airflow which is measured is the pressure inside the hollow body. The pressure inside the hollow body in the airflow generated by the suction device and coming from the suction opening, makes it possible to reliably detect a rise in internal pressure above a threshold value and/or according to a growth slope greater than a threshold value, which is characteristic of a state of separation of the airflow around the wing upstream of the suction area on the peripheral wall, i.e. of a stall of the wing. It may be anticipated that the angle of incidence for which this pressure rises above a threshold value and/or has a growth slope greater than a threshold value is defined as the stall angle.

Another object of the invention is a method for controlling the angle of incidence of a lift generating device, called a wing, of a wind-assisted propulsion system relative to the direction of the apparent wind, the wing comprising a hollow body, the wing being located in an outer airflow incident on the wing; the wind-assisted propulsion system comprising:
a suction device in fluid communication with the hollow body;
at least one suction opening provided in a peripheral wall of the hollow body subjected to said outer airflow incident on the wing, the suction device generating an air flow inside the hollow body from said at least one suction opening;
a device for measuring a parameter representative of the state of separation of the airflow incident on the wing;
   characterized in that the method comprises the following steps:
a) measuring the direction of the apparent wind;
b) pivotally displacing the wing about a vertical pivot axis, to allow the chord line of the profile of the wing to take different values for the angle of incidence relative to the direction of the apparent wind, and,
c) during the pivotal displacement of the wing, measuring said parameter representative of the state of separation of the airflow incident on the wing as a function of the angle of incidence value of the wing; and, from the measurement of said parameter representative of the state of separation of the airflow incident on the wing, determining a value for the angle of incidence of the wing corresponding to a stall, called a stall angle value;
d) determining a safety value for the angle of incidence of the wing, as a function of said stall angle value, the angle of incidence safety value of the wing being, in absolute value, lower than said stall angle value;
e) controlling the orientation of the wing with an angle of incidence set value that is equal to the angle of incidence safety value.

### BRIEF DESCRIPTION OF THE DRAWINGS

Other characteristics and advantages of the invention will emerge from the description which follows, which is purely illustrative and not limiting and must be read with reference to the appended drawings, in which:

FIG. 1 is a schematic cross-sectional view of a wind-assisted propulsion system according to one embodiment of the invention, the system being mounted on the deck of a boat;

FIG. 2 is a schematic view of the wing of the system of FIG. 1, with a representation of an authorized angular range of incidence, defined as a function of a first measured stall angle value, the wing having an angle of incidence contained within the authorized angle range, and the wing not being subject to stall;

FIG. 3 is a schematic view of the wing of FIG. 2 which has an angle of incidence, greater than that of FIG. 2, for which a stall is detected while the angle of incidence is still located within the authorized range;

FIG. 4 is a schematic view of the wing of FIG. 3 after redefinition (updating) of the authorized angle of incidence range, as a function of a new stall angle value corresponding to the angle of incidence in FIG. 3 for which the stall was detected;

FIG. 5 is a schematic view of the wing of FIG. 4 which has an angle of incidence included in the new authorized angle of incidence range;

FIG. 6 is a curve giving the opposite of the pressure coefficient (−Cp) as a function of the angle of incidence measured during the pivotal displacement of the wing to determine the actual stall angle;

FIG. 7 is a flowchart comprising steps of a method for controlling the angle of incidence of the wing of a wind-assisted propulsion system according to one embodiment of the invention.

### DETAILED DESCRIPTION

The concept of the invention is described more fully below with reference to the accompanying drawings, in which embodiments of the concept of the invention are shown. In the drawings, the size and the relative sizes of the elements may be exaggerated for clarity. Like numbers refer to like elements on all drawings. However, this concept of the invention may be implemented in many different forms and should not be construed as being limited to the embodiments disclosed herein. Instead, these embodiments are provided so that this description is complete, and communicate the scope of the concept of the invention to those skilled in the art.

Reference throughout the specification to “one embodiment” means that a particular functionality, structure, or characteristic described in connection with one embodiment is included in at least one embodiment of the present invention. Thus, the appearance of the phrase “in one embodiment” in various locations throughout the specification does not necessarily refer to the same embodiment. Furthermore, the particular functionalities, structures, or characteristics may be combined in any suitable manner in one or several embodiments.

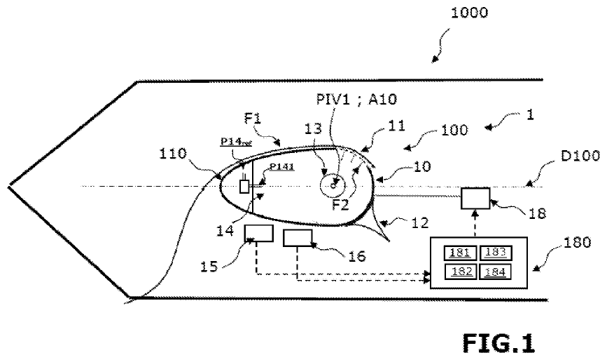

With reference to the figures, a wind-assisted propulsion system 1, also called a wind-assisted propeller, is represented. As illustrated in FIG. 1, the wind-assisted propulsion system 1 is located on the deck of a boat 1000.

The wind-assisted propulsion system 1 is placed in a moving air flow F1 which makes it possible to produce a lift force. As detailed below, this system is driven to optimize the lift force while limiting the risk of stall, which improves the operating efficiency of the system.

### Wing

The wind-assisted propulsion system 1 includes a lift generating device, called a suction wing 100, which has an aerodynamic profile. The following description is made for one wing, but also applies to a plurality of wings.

The wing 100 comprises a hollow body 10 elongated along an axis A10, with which a suction device 13 is in fluid communication as explained below. The axis A10 is orthogonal to the plane of the deck of the boat, i.e. substantially vertical, when the wing is in use configuration. The hollow body is a rigid body unlike a sailboat sail for example.

Preferably, the wing also comprises a fairing 110 (which delimits an enclosure devoid of airflow) attached to an outer part, referred to as the front part, of the peripheral wall of the hollow body 10. The aerodynamic profile of the wing is defined by the outer profile of the fairing and the outer profile of the hollow body. Different profile shapes may be used. In the example illustrated in the figures, the profile of the wing is ovoid in shape. The profile of the wing corresponds to a cut (section) along a plane orthogonal to the axis A10 of the hollow body.

The peripheral wall of the hollow body 10 of the wing has at least one opening 11, called a suction opening, capable of communicating with the interior of the hollow body 10 of the wing 100. According to one embodiment, the peripheral wall 10 has two suction openings, preferably distributed symmetrically with respect to an axis of symmetry of the profile of the wing.

According to one embodiment, the hollow body 10 is provided with a movable flap 12. The flap allows to modify the camber of the profile of the wing in order to increase lift, whether the wind comes from one side or the other of the ship. The ship can sail on both tacks—port tack or starboard tack. According to one embodiment, it can be provided that the displacement of the flap makes it possible to close a suction opening 11 and to release the other suction opening.

### Suction Device

The wind-assisted propulsion system comprises a suction device 13 in communication with the interior of the hollow body 10 of the wing 100 to suck air through said at least one opening 11 provided in the peripheral wall of the wing.

It can be provided that each suction opening 11 has an opening or porosity dimension variable along the wing, for example to vary the quantity of air sucked in as a function of the position along the wing. Each opening 11 may be made in the form of a grid.

In the example illustrated in the figures, the suction device 13 is formed by a fan which is in fluid communication with the hollow body 10. The fan may be of the centrifugal or helico-centrifugal fan type. The fan can be located inside or outside the hollow body while being in fluid communication with the hollow body. The fan is configured to allow air circulation to be generated through the hollow body with suction at the suction opening 11 to, at the area of the suction opening 11, promote maintenance of the air layer of the outer flow against the peripheral wall of the hollow body.

As illustrated in FIG. 1, the suction opening 11 allows an outer airflow F1 which arrives at the suction opening 11, to be at least partly sucked into the hollow body 10 using the fan 13 and thus to form from the suction opening 11 an inner air flow F2 which passes through the fan 13. The fan 13 is configured to discharge the sucked air flow in the open air.

### Pivoting of the Wing

The wind-assisted propulsion system 1 comprises a support (not represented) on which and relative to which the wing 100 is pivotally mounted. Preferably, the wing is pivotally mounted on the support about an axis substantially parallel to the longitudinal axis A10 of the hollow body 10 of the wing 100. It is understood that the pivot axis PIV1 is preferably parallel to the axis A10, but that the pivot axis may have a slight angle of one or a few degrees relative to the axis A10, for example an angle which is lower than 5°.

For this purpose, the wind-assisted propulsion system 1 comprises a motorized system 18 for pivoting the wing.

Thus, in the mounted state of the system on the deck of the boat 1000, the wing 100 may rotate about the axis A10 (vertical) while being controlled by the motorized pivoting system 18, itself even controllable by the drive unit 180, so as to orient the wing relative to the direction of the apparent wind. As explained below, the orientation of the wing is controlled or regulated as a function of the desired lift and so as to reduce the risk of stall.

In the configuration of use of the system where the wing 100 is raised on the deck of the ship, such as a cargo, through its support, the support is stationary relative to the deck.

The wing 100 is thus mounted pivotally movable relative to the boat about its vertical pivot axis PIV1, to allow the chord line D100 (also called direction of orientation) of the profile of the wing 100 to take different values for the angle of incidence A1 relative to the direction of the apparent wind V1.

The chord line (or direction of orientation) D100 of the profile of the wing 100 may be defined as being the straight line which connects the leading edge of the wing to the trailing edge, as seen from the wing along a cutting (section) plane orthogonal to the longitudinal axis A10 of the hollow body.

Preferably and as illustrated in FIG. 1, the wing 100 is provided with a flap 12. The flap makes it possible to modify the camber of the profile of the wing in order to increase the lift, whether the wind comes from one side or the other of the ship. The ship may sail on both tacks-port tack or starboard tack. According to one embodiment, it can be provided that the displacement of the flap makes it possible to close a suction opening and to release another suction opening when the wing has several suction openings.

A system for measuring the direction of the apparent wind V1 is provided, such as a wind vane, which may be mounted on the wing 100 or on the boat 1000. The apparent wind may thus be measured at the wing 100 or nearby, upstream or downstream, of the wing for example on the front of the boat equipped with the wing.

A method is proposed making it possible to control the angle of incidence A1 of the wing relative to the direction of the apparent wind V1, to make it possible to optimize the lift of the wing 100 and therefore the efficiency of the system 1, i.e. to maximize lift reliably with a reduced risk of stall.

### Apparent Wind Measurement

The direction of the apparent wind V1 is measured using a device 15 for measuring direction of the wind, such as a wind vane positioned on the wing. Alternatively and or in addition: the measurement may be carried out using a wind vane located on a part of the boat provided with the wing.

The apparent wind direction serves as a reference to control the angle of incidence A1 of the wing relative to the direction of the apparent wind V1.

According to one embodiment, the speed (or force) of the apparent wind is also measured by a device 16 for measuring wind speed, for example using an anemometer, which is preferably located in the same area or near the wind direction device.

It is useful to measure the wind speed because the aerodynamic performance of the wind-assisted propeller may be affected in various ways. The stability of atmospheric air may cause variations in wind direction to be more or lower marked and more or lower rapid. The stability of the air also has an influence on the more or lower early appearance of the stall.

### Measurement of a Parameter Representative of the State of Stall of the Wing

The wind-assisted propulsion system 1 includes a device for measuring a parameter relating to the state of the airflow F1 incident on the wing at the suction opening 11 which is in fluid communication with the suction device. Said parameter is in particular a parameter representative of the state of stall of the wing, in particular the state of separation of the airflow incident on the wing, upstream of the suction opening 11 by which the air flow F2 is set in motion inside the hollow body 10 of the wing by the suction device.

According to a preferred embodiment, said measured parameter is the pressure inside the hollow body, in particular the pressure inside the hollow body in the air flow F2, set in motion by the suction device 13, said measured pressure preferably being the pressure in the internal flow F2 between the suction opening 11 and the suction device 13.

The air flow F2 is considered from said suction opening 11 (upstream of the fan), and this air flow emerges downstream of the suction device 13 either by an outlet which can be provided in the hollow body 10 when the suction device 13 is located in the hollow body or by an outlet from the suction device 13 when the suction device 13 is located outside the hollow body but of course in fluid communication with the hollow body.

According to a preferred embodiment, the device for measuring a parameter relating to the state of the incident airflow F1 comprises a pressure sensor system 14 configured to measure the pressure in the flow F2 inside the hollow body, between the suction opening 11 and the fan 13. The pressure sensor system may comprise one or several sensors.

According to a particular aspect, the pressure sensor system 14 comprises a sensor of differential pressure sensor type. As shown schematically in FIG. 1, the sensor comprises a pressure tap P141 in the hollow body. The sensor may be housed inside the hollow body 10 or, as in the case of FIG. 1, outside the hollow body 10 but in fluid communication with the hollow body 10. For example the sensor may be housed under cover in the fairing 110 with a pressure tap P141 which emerges into the hollow body to measure the pressure inside the hollow body in which circulates the air flow F2 set in motion by the fan. The differential sensor has another pressure tap P14ref which serves as a reference. The reference pressure tap P14ref is located in an area without air flow, for example in the gap defined between the front fairing 110 and the hollow body 10, to measure the atmospheric pressure (static air pressure in the fairing). Alternatively, the reference pressure tap may be located at any other location in the system, apart from flows F1 and F2, where the flow speed is zero.

The description is made below in the case where the device for measuring a parameter relating to the state of the airflow F1 incident on the wing is an internal pressure measuring device which allows to measure the pressure in the internal flow F2 inside the hollow body 10. As explained below, the measurement of this internal pressure, and in particular its variation as a function of the angle of incidence of the wing, makes it possible to reliably determine the state of separation of the incident air flow F1 on the wing, and therefore the state of stall of the wing, as a function of the angle of incidence of the wing. However, the description may apply to other embodiments, which remain less advantageous than a pressure sensor measuring the pressure inside the hollow body through which the flow F2 is sucked, for which the device for measuring a parameter relating to the state of the airflow F1 incident on the wing may be a wall pressure sensor, or an electronic telltale (i.e. a flexible strip associated with electronic processing means), positioned on the wing in the flow F1 or a device for analyzing operating parameter(s) of the fan, such as intensity, consumed power and/or rotational speed.

### Drive Unit

The device comprises a drive unit 180 which comprises a module 181 for controlling pivoting and recording a corresponding pressure. The module 181 is configured to control the pivoting of the wing 100 about its vertical pivot axis PIV1, which may coincide with the central axis A10 of the hollow body 10, in a given angular range to allow the (horizontal) axis of orientation D100 of the wing 100 to take different values for the angle of incidence A1 relative to the direction of the apparent wind V1, and, during the pivotal displacement of the wing 100, to control the recording of the pressure measurement inside the hollow body as a function of the angle of incidence value A1 of the wing 100.

The drive unit 180 also comprises a stall determination module 182 configured to determine a value A1D_t2 for the angle of incidence of the wing 100 corresponding to a stall, called a stall angle value. The module 182 is configured to detect a passage of a parameter relating to the pressure, such as the opposite of the pressure coefficient (−Cp), above or below (depending on the used parameter) a threshold value. Note that a rise in pressure inside the hollow body in the flow F2 above a threshold value corresponds to a separated state of the airflow F1 around the wing at the suction opening 11. In particular, in the unstalled state of the wing subjected to an incident air flow, the pressure is negative inside the hollow body 10 in the flow F2. Then, when the flow F1 separates upstream of the suction opening 11, the pressure inside the hollow body 10 in the flow F2 rises and the parameter −Cp falls.

The pressure coefficient Cp is calculated as a function of the measured apparent wind speed Vv1. The pressure coefficient Cp may be calculated by the formula:

$${C}_{p} = \frac{P\_i}{\frac{1}{2} ρ Vv {1}^{2}}$$

with P_i the internal pressure measured in the hollow body by the pressure sensor, and p the density of the air.

It should be noted that the lift of the wing is linked to the pressure coefficient itself calculated from the measured internal pressure.

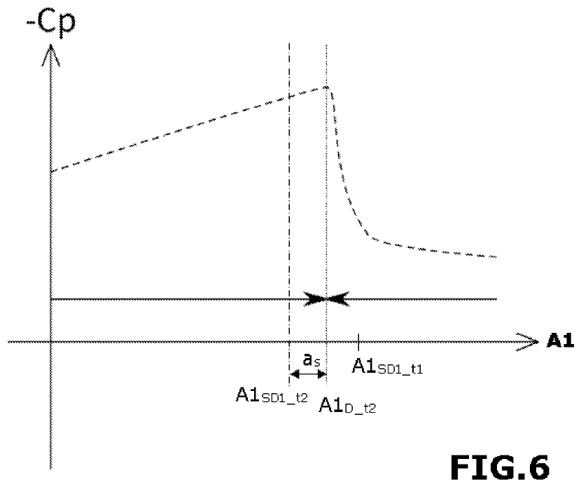

An example of the evolution of the opposite of the pressure coefficient −Cp, as a function of the angle of incidence A1 of the wing measured during said pivotal displacement of the wing is proposed in FIG. 6.

It can thus be provided that the module determines the angle of incidence value A1D_t2 of the wing 100 corresponding to a stall as being the angle of incidence of the wing for which the value of −Cp passes below a given threshold value and/or has a decay slope that is greater than a given threshold value.

The drive unit 180 also comprises a safety module 183 configured to determine a safety value A1SD1_t2 for the angle of incidence of the wing, as a function of the stall angle value A1D_t2, which is, in absolute value, lower than said stall angle value. The angle of incidence safety value may correspond to the determined stall angle value reduced by a given value, referred to as a spacing value, as explained below. The use of a safety value for the angle of incidence that is lower, in absolute value, than the stall angle actually measured, makes it possible to maintain the maximum angle of incidence of the wing spaced apart from the stall angle to limit the risk of unintentional stall.

The drive unit 180 also comprises a module 184 for controlling orientation of the wing which makes it possible to control the orientation of the wing via the motorized system 18 as a function of the desired lift. The module 184 for controlling orientation of the wing thus makes it possible to control the orientation of the wing with an angle of incidence set value that is equal to the angle of incidence safety value A1SD1_t2 to obtain a maximum lift in a secure manner. The module 183 for controlling orientation of the wing also makes it possible to control the orientation of the wing with an angle of incidence set value that is lower than the angle of incidence safety value A1SD1_t2, in particular comprised between 0° and A1SD1_t2 in given conditions where lower lift is desired, for example for slowing down or stopping the boat.

### Spacing Value

According to one embodiment, the angle of incidence safety value A1SD1_t2 is calculated according to the formula:

$$‖ A 1 SD 1 \_t 2 ‖ = ‖ A 1 D\_t 2 ‖ - {a}_{s}$$

With aₛ a strictly positive value, referred to as a spacing value.

The spacing value as may be a predefined value, such as a value comprised between 2° and 8°, for example 3°.

According to one embodiment, the spacing value as is defined as a function of a parameter of the environment of the device, such as the speed of the apparent wind.

### Updating of the Angle of Incidence Safety Value

After a first cycle of execution of the steps which make it possible to obtain a first stall angle value and a first safety value for the angle of incidence, the drive unit 180 is configured to repeat the steps in a second execution cycle so as to obtain a second stall angle value and a second safety value for the angle of incidence for updating the angle of incidence safety value. It is understood that the obtained second angle of incidence safety value, which corresponds to the updating of the angle of incidence safety value, may be greater or lower than the first angle of incidence safety value.

For at least one or each cycle (execution process), it can be provided that the wing is displaced until (i.e. stopping the displacement when) a stall is detected. Alternatively or in combination, it can also be provided that the angular sector in which the wing is pivotally displaced extends on either side of the stall angle value obtained during a previous execution process.

Repeating the steps makes it possible to update the angle of incidence safety value by replacing the old determined value with the new value for the set value of controlling orientation of the wing.

It can be provided that the steps are repeated periodically to obtain a measurement for the stall angle and therefore a safety value setpoint for the angle of incidence which is appropriate as a function of the navigation conditions. It can be also provided that the repetition of the steps is triggered as a function of one or several environmental parameters, such as the direction and/or speed of the wind, the weather conditions, or the operation of the device, such as the rotational speed of the fan.

It can be provided that the determined second stall angle value and the resulting angle of incidence safety value automatically replaces the previous values. Alternatively, il can also be provided to compare one of the determined second values with the corresponding first value(s) and to update one or several of said determined values when the difference between the compared values is greater than a threshold value.

The angle of incidence of the wing may thus be regulated so as to maximize the propulsive force delivered to the boat by the wind-assisted propulsion system when conditions permit or so as to reduce or minimize the effect of the wind on the ship when necessary.

The regulation of the angle of incidence of the wing may be driven by the drive unit either in open loop or in closed loop. In open loop, the set values delivered to the operating parameters are calculated explicitly from the available information and the actual state of the quantity associated with the set value is not compared to this set value. In closed loop, the quantity associated with a set value is measured. The difference between the current value and the set value for this quantity is taken into account and modifies the behavior of the regulation system.

### Method

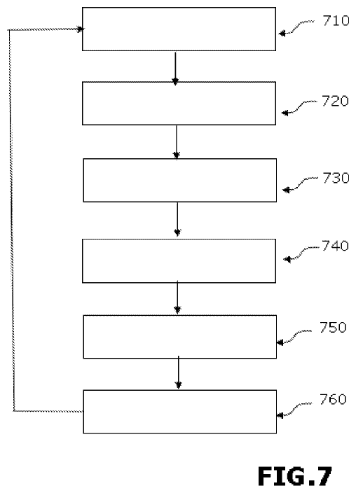

The wind-assisted propulsion system presented above allows the implementation of a method for controlling the angle of incidence A1 of the wing so as to optimize the lift effort while limiting the risk of unintentional stall. One embodiment of such a method is proposed below in connection with FIG. 7.

The suction device 13 operates so that an air flow F2 circulates through the hollow body from the suction opening 11. In particular, it can be provided that the drive unit controls the rotation of the fan at a given speed.

In step 710, the direction of the apparent wind V1 is measured using the measuring device 15. Advantageously, the wind speed is also measured using the measuring device 16.

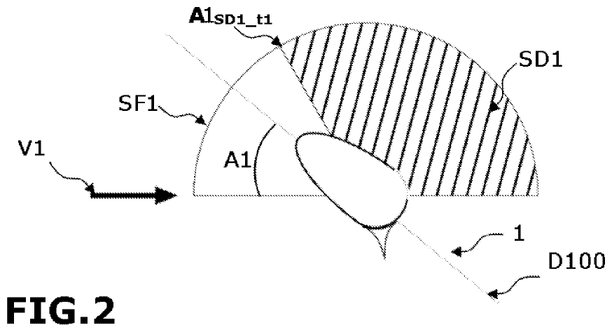

As illustrated in FIG. 2, the angle of incidence A1 of the wing 100 is in an authorized angular sector of incidence SF1 whose maximum value (in absolute value) is A1SD1_t1. The prohibited complementary sector is referenced SD1.

In step 720, the drive unit 180 controls the pivotal displacement of the wing 100 about its vertical pivot axis PIV1, to allow the chord line D100 of the profile of the wing to take different values for the angle of incidence A1 relative to the direction of the apparent wind V1. The drive unit controls the recording of the internal pressure values measured by the sensor 14 as a function of the angle of incidence value A1 taken by the wing during the pivotal displacement of the wing 100. The wing is displaced over an angular range suitable for a stall to occur.

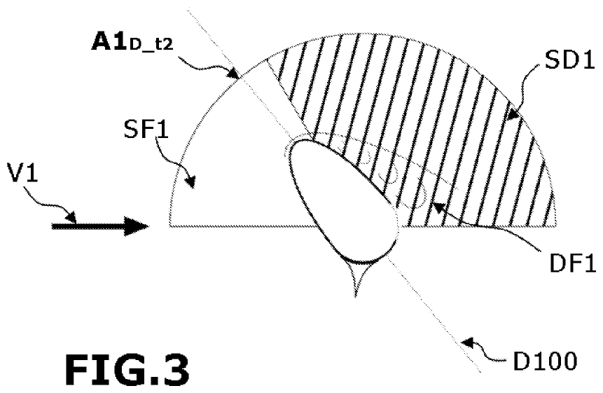

In step 730, from the internal pressure measurements measured by the sensor 14, the drive unit determines a value A1D_t2 for the angle of incidence of the wing corresponding to a stall, called a stall angle value. This angle of incidence value A1D_t2 of the wing is illustrated in FIG. 3 with the separation of the flow referenced DF1. The recorded pressure measurements may be used to calculate values of a parameter, such as the opposite of the pressure coefficient (−Cp), as a function of the measured angle of incidence, as illustrated in FIG. 6, and allow thus to determine a corresponding stall angle by analyzing the evolution of this parameter as a function of the angle of incidence A1.

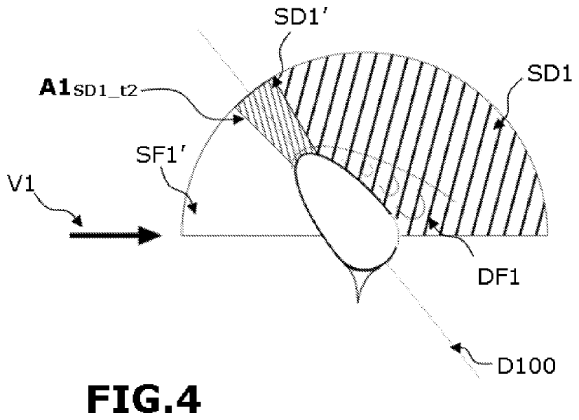

In step 740, the drive unit determines a safety value A1SD1_t2 for the angle of incidence of the wing, as a function of said stall angle value A1D_t2, which is lower than said stall angle value. The authorized angular sector of incidence may thus be updated so that as illustrated in FIG. 4, a sector SF1′ is obtained, which may be reduced compared to the previous authorized sector, while the updated prohibited sector SD1′ has increased.

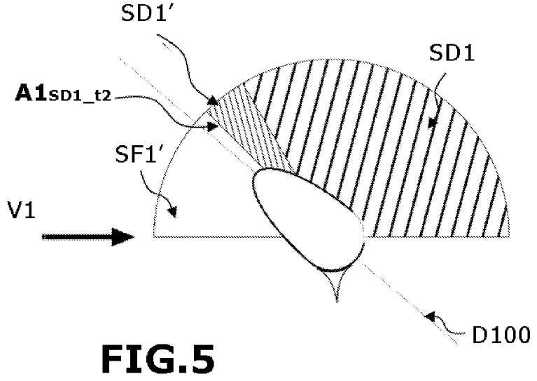

In step 750, the drive unit controls the orientation of the wing with an angle of incidence set value that is equal to or lower than the angle of incidence safety value A1SD1_t2, as illustrated in FIG. 5.

In step 760, the previous steps are repeated to obtain a new safety value for the angle of incidence. In other words, the angle of incidence safety value, corresponding, in absolute value, to the maximum authorized angle of incidence is updated and thus replaces the determined old angle of incidence safety value used to generate the set value of controlling orientation of the wing.

After the execution of steps 710 to 750, also called steps a) to e), providing a stall angle value and a safety value for the angle of incidence, the following steps may be preferably performed in real time, for example at a given frequency, such as 10 Hz:
determining the angular position where the wing 100 is located, to which corresponds a value for the angle of incidence A1 of the wing 100, and measuring said parameter representative of the state of separation of the airflow F1 incident on the wing; and,
determining by the drive unit 180 the state of stall or not of the wing as a function of said measured parameter representative of the state of separation of the airflow F1 incident on the wing.

In case of detection of a stall state, it can be provided that: either steps 710 to 750 are repeated in an additional execution process; or, the drive unit 180 assigns to the stall angle value, said determined value for the angle of incidence A1 of the wing 100 (value for the angle of incidence A1 considered at the time of the measurement which made it possible to detect the stall state), then the drive unit 180 determines a safety value for the angle of incidence of the wing as a function of said stall angle value, the angle of incidence safety value being, in absolute value, lower than said stall angle value. The drive unit 180 may then control the orientation of the wing with an angle of incidence set value that is equal to the angle of incidence safety value.

In the absence of stall detection, the drive unit may be configured to wait for the repetition of steps 710 to 750 for the next time. It can be provided that in step 720 of the execution process, the wing is displaced until a stall is detected and/or the angular sector in which the wing is pivotally displaced extends from either side of the stall angle value obtained during the previous execution process.

The angle of incidence safety value may thus be modified, temporarily or not, for the encountered conditions, so as to improve the performance of the system.

In case of an unintentional stall, i.e. outside the learning phase, it can be provided that the system reduces the incidence until the flow recovers and therefore until the aerodynamic performance of the profile is restored or to an even lower value of incidence then restarts a learning process to then be able to control the orientation of the wing according to a set angle of incidence corresponding to the new value for the maximum authorized angle of incidence. Alternatively, it can be provided that the observed value of the stall is used in the same way as in step 730, i.e. by resuming the cycle in step 740 using the value of the stall angle observed as resulting from step 730, and therefore without necessarily restarting a complete learning cycle.

The drive unit is for example in the form of a processor and a data memory in which are stored computer instructions executable by said processor, or even in the form of a microcontroller.

In other words, the functions and steps described may be implemented in the form of a computer program or via hardware components (e.g. programmable gate arrays). In particular, the functions and steps operated by the drive unit or its modules may be carried out by instruction sets or computer modules implemented in a processor or controller or be carried out by dedicated electronic components or components of the programmable logic circuit (or FPGA) type or application-specific integrated circuit (or ASIC) type. It is also possible to combine computer parts and electronic parts.

The drive unit is thus an electronic and/or computer unit. When it is specified that said unit is configured to carry out a given operation, this means that the unit comprises computer instructions and the corresponding execution means which make it possible to carry out said operation and/or that the unit comprises corresponding electronic components.

### Other Aspects

It can be provided that the system 1 comprises a tilting mechanism which makes it possible to tilt the wing, and possibly its support, about a horizontal axis.

The tilting system makes it possible to displace the wing, and possibly its support, between an erect position, in which, in the mounted state of the system on the deck of the boat, it extends perpendicular to the deck of the boat, and a tilted position, in which, in the mounted state of the system on the deck of the boat, the wing extends substantially parallel to the deck of the boat.

When the wing extends vertically and pivots about an axis substantially parallel to the axis of the wing, that is to say during operation of the wing—in the vertical state of the wing—and apart from the possible tilting mobility of the support about an axis orthogonal to the axis of the wing, the support remains stationary relative to the deck of the boat.

In general, it can be provided that the system takes up all or part of the characteristics of the lift generating system described in international application PCT/FR2022/050268 published under number WO/2022/175622, or of the system described in the patent filed under number EP17165662 and published under number EP3235719, by adding the additional elements presented above, with in particular the pressure measuring device and the drive unit as presented above.

The invention is not limited to the embodiments illustrated in the drawings. Furthermore, the term “comprising” does not exclude other elements or

steps. Furthermore, characteristics or steps that have been described with reference to one of the embodiments disclosed above may also be used in combination with other characteristics or steps of other embodiments disclosed above.

1. A method for controlling the angle of incidence of a lift generating device, called wing, of a wind-assisted propulsion system relative to a direction of an apparent wind, the wing comprising a hollow body, the wing being located in an outer airflow incident on the wing;
the wind-assisted propulsion system comprising:
a suction device in fluid communication with the hollow body;
at least one suction opening provided in a peripheral wall of the hollow body subjected to the outer airflow incident on the wing, the suction device generating an air flow inside the hollow body from the at least one suction opening;
a device for measuring a parameter representative of a state of separation of the outer airflow incident on the wing;
a motorized system for pivoting the wing about a vertical pivot axis parallel to a longitudinal axis of the hollow body;
a drive unit;
the method comprising:
a) measuring the direction of the apparent wind by a device for measuring the direction of the apparent wind;
b) pivotally displacing the wing about the vertical pivot axis by the motorized system for pivoting of the wing, to allow a chord line of the profile of the wing to take different values for the angle of incidence relative to the direction of the apparent wind, and,
c) during a pivotal displacement of the wing, measuring, by the device for measuring the parameter representative of the state of separation, the parameter representative of the state of separation of the outer airflow incident on the wing as a function of the angle of incidence value of the wing; and, from the measurement of the parameter representative of the state of separation of the outer airflow incident on the wing, determining by the drive unit a stall angle value for the angle of incidence of the wing corresponding to a stall, called stall angle value;
d) determining, by the drive unit, an angle of incidence safety value for the angle of incidence of the wing as a function of the stall angle value, the angle of incidence safety value being, in absolute value, lower than the stall angle value;
e) controlling, by the drive unit, an orientation of the wing with an angle of incidence set value that is equal to the angle of incidence safety value.

2. The method according to claim 1, wherein, after performing a first execution of actions a) to e) providing the stall angle value as a first stall angle value and the angle of incidence safety value as a first angle of incidence safety value, performing a second execution of actions a) to e) so as to obtain a second stall angle value and a second angle of incidence safety value corresponding to an update of the angle of incidence safety value.

3. The method according to claim 2, wherein, in action b) of the second execution, the wing is displaced until a stall is detected and/or an angular sector wherein the wing is pivotally displaced extends on either side of the stall angle value obtained during the first execution.

4. The method according to claim 1, wherein, after the first execution of actions a) to e) providing a first stall angle value and a first angle of incidence safety value,
the method comprises:
determining an angular position where the wing is located, to which corresponds a value for the angle of incidence of the wing, and measuring the parameter representative of a state of separation of the outer airflow incident on the wing; and,
determining, by the drive unit, a state of stall or not of the wing as a function of the measured parameter representative of the state of separation of the outer airflow incident on the wing;
and, in case of detection of a state of stall:
either repeating actions a) to e) in a second execution;
either, assigning to the stall angle value, by the drive unit, the determined angle of incidence value of the wing, determining, by the drive unit, a safety value for the angle of incidence of the wing as a function of the stall angle value, the angle of incidence safety value being, in absolute value, lower than the stall angle value;
controlling, by the drive unit, the orientation of the wing with an angle of incidence set value that is equal to the angle of incidence safety value.

5. The method according to claim 1, wherein the device for measuring the parameter representative of the state of separation of the outer airflow incident on the wing comprises a pressure sensor system configured to measure a pressure in an air flow inside the hollow body.

6. The method according to claim 5, wherein the pressure sensor system is configured to measure the pressure in the air flow inside the hollow body between the at least one suction opening and the suction device.

7. The method according to claim 5, wherein the pressure sensor system comprises a differential pressure sensor, the differential pressure sensor comprising a pressure tap located inside the hollow body.

8. The method according to claim 7, wherein
the wing comprises a fairing coupled to a peripheral wall of the hollow body, and
the differential pressure sensor comprises a reference pressure tap located in the fairing.

9. The method according to claim 1, wherein the angle of incidence safety value is calculated by the formula:
$$‖ A 1 SD 1 \_t 2 ‖ = ‖ A 1 D\_t 2 ‖ - {a}_{s}$$
where
A1SD1_t2 is the angle of incidence safety value,
A1D_t2 is the stall angle value, and
aₛ is a strictly positive value, called spacing value.

10. The method according to claim 9, wherein the spacing value is a predefined value.

11. The method according to claim 9, wherein the spacing value is a function of a speed of the apparent wind.

12. The method according to claim 1, wherein the stall angle value is determined as being the angle of incidence value for which the parameter representative of the state of separation of an outer airflow incident on the wing crosses a threshold value and/or has a slope value which crosses a threshold value.

13. The method according to claim 1, wherein the direction of the apparent wind is measured using a wind vane positioned on the wing.

14. The method according to claim 1, wherein the device for measuring a parameter representative of the state of separation of the outer airflow incident on the wing comprises a wall pressure sensor, positioned on the wing in the outer airflow incident upstream of the at least one suction opening.

15. The method according to claim 1, wherein the device for measuring a parameter representative of the state of separation of the outer airflow incident on the wing comprises a flexible strip associated with an electronic telltale positioned on the wing in the outer airflow incident on the wing upstream of the at least one suction opening.

16. The method according to claim 1, wherein the device for measuring a parameter representative of the state of separation of the outer airflow incident on the wing comprises a device for analyzing an operating parameter or operating parameters of the suction device.

17. A wind-assisted propulsion system comprising:
a lift generating device, called a wing, the wing comprising a hollow body, the wing being intended to be located in an outer airflow incident on the wing;
a suction device in fluid communication with the hollow body;
at least one suction opening provided in a peripheral wall of the hollow body capable of being subjected to the outer airflow incident on the wing, the suction device being configured to generate an air flow inside the hollow body from the at least one suction opening;
a device for measuring a parameter representative of the state of separation of the outer airflow incident on the wing;
a motorized system for pivoting the wing about a pivot axis parallel to a longitudinal axis of the hollow body; and
a drive unit configured to execute the steps of a method for controlling the angle of incidence of the wing relative to the direction of the apparent wind, the method comprising:
a) measuring the direction of the apparent wind by a device for measuring the direction of the apparent wind;
b) pivotally displacing the wing about the vertical pivot axis by the motorized system for pivoting of the wing, to allow a chord line of the profile of the wing to take different values for the angle of incidence relative to the direction of the apparent wind, and,
c) during a pivotal displacement of the wing, measuring, by the device for measuring the parameter representative of the state of separation, the parameter representative of the state of separation of the outer airflow incident on the wing as a function of the angle of incidence value of the wing; and, from the measurement of the parameter representative of the state of separation of the outer airflow incident on the wing, determining by the drive unit a stall angle value for the angle of incidence of the wing corresponding to a stall, called stall angle value;
d) determining, by the drive unit, an angle of incidence safety value for the angle of incidence of the wing as a function of the stall angle value, the angle of incidence safety value being, in absolute value, lower than the stall angle value:
e) controlling, by the drive unit, an orientation of the wing with an angle of incidence set value that is equal to the angle of incidence safety value.

18. A Boat equipped with the wind-assisted propulsion system according to claim 17, the wind-assisted propulsion system being mounted on a deck of the boat.

19. The method according to claim 4, wherein the determining actions, and in case of detection of a state of stall, the second execution and the assigning, determining, and controlling are performed at a given frequency.

20. The method according to claim 6, wherein the pressure sensor system comprises a differential pressure sensor, the differential pressure sensor comprising a pressure tap located inside the hollow body.
